(19) United States
(12) Patent Application Publication
(10) Pub. No.: US 2006/0191293 A1
(43) Pub. Date: Aug. 31, 2006

(54) Furnace and process for drawing radiation resistant optical fiber

(75) Inventor: Andrew S. Kuczma, Clinton, CT (US)

Correspondence Address: PATTERSON & SHERIDAN, L.L.P., 3040 POST OAK BOULEVARD, SUITE 1500, HOUSTON, TX, 77056, US

(73) Assignee: Weatherford/Lamb, Inc.

(21) Appl. No.: 11/363,812

(22) Filed: Feb. 28, 2006

Related U.S. Application Data
(60) Provisional application No. 60/657,161, filed on Feb. 28, 2005.

(51) Int. Cl. C03B 37/07; C03B 25/10; C03B 37/027; F27B 1/26

(52) U.S. Cl. 65/384; 65/435; 65/533; 65/118; 65/488

(57) ABSTRACT

Apparatus and methods to fabricate a radiation hardened optical fiber from a preform are provided. Various parameters affecting the draw process are controlled to optimize the radiation resistance of the resulting fiber. An annealing zone may be provided to allow a drawn fiber exiting a primary hot zone to undergo an annealing process which may increase radiation resistance.

### CROSS-REFERENCE TO RELATED APPLICATIONS

This application claims benefit of U.S. Provisional patent application Ser. No. 60/657,161 filed Feb. 28, 2005, which is incorporated herein by reference.

### BACKGROUND OF THE INVENTION

1. Field of the Invention

Embodiments of the present invention generally relate to optical fibers and, more particularly, to a furnace and process for drawing optical fibers from a preform.

2. Description of the Related Art

Optical fibers and other type waveguides are typically formed by heating and drawing an optical fiber preform. The preform typically includes a core and surrounding cladding, with appropriate dopants to achieve desired characteristics of the resulting drawn fiber.

Standard telecommunications optical fibers are highly susceptible to optical signal losses caused by nuclear or ionizing radiation. Careful selection of dopants and process conditions during glass fabrication have been shown to improve radiation resistance. For example, U.S. Pat. No. 5,509,101 to Gilliad et al., describes a silica fiber doped with fluorine doping in the core and a portion of the cladding drawn at low draw tension, while U.S. Pat. No. 5,681,365 to Gilliad et al. describes a silica fiber doped with fluorine doping in the core and a portion of the cladding drawn at low draw tension with additional germanium doping in a portion of the cladding. Both of these patents are hereby incorporated by reference in their entirety.

Conditions of the final fiber draw process are also important in optimizing the radiation resistance of the final fiber article. Improper fiber draw conditions can be detrimental to radiation resistance. While this phenomena is not completely understood, it is believed that non-optimized draw conditions cause internal stress within the waveguide. These stresses may place the chemical bonds of the glass matrix under strain. Radiation can rupture these strained bonds causing defect sites within the glass leading to increased optical signal attenuation.

Accordingly, what is needed are improved apparatus and methods for drawing radiation resistant optical fiber.

### SUMMARY OF THE INVENTION

Embodiments of the present invention generally provide apparatus and methods for drawing radiation resistant optical fiber.

One embodiment provides an apparatus for drawing an optical fiber from an optical fiber preform. The apparatus generally includes a first furnace for heating a first zone in which the preform is heated to draw an optical fiber therefrom and an annealing zone through which the drawn fiber passes after exiting the first zone to undergo an annealing process.

Another embodiment provides a method for drawing an optical fiber from an optical fiber preform. The method generally includes heating the preform in a first zone at a first temperature to draw an optical fiber therefrom and annealing the drawn fiber in an annealing zone after it exits the first zone, wherein the annealing zone is maintained at a second temperature.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary draw furnace, in accordance with one embodiment of the present invention;

FIG. 2 illustrates an exemplary draw furnace, in accordance with another embodiment of the present invention; and

FIG. 3 illustrates exemplary preform compositions, in accordance with one embodiment of the present invention.

### DETAILED DESCRIPTION OF THE PREFERRED EMBODIMENT

Embodiments of the present invention provide various apparatus and methods to fabricate a radiation hardened optical fiber from a preform. Various parameters affecting the draw process are controlled to optimize the radiation resistance of the resulting fiber. In some cases an annealing zone may be provided at the bottom of a draw furnace, allowing a drawn optical fiber to undergo an annealing process after exiting a primary hot zone. This annealing process may relax internal stresses and increase radiation resistance of the drawn fiber.

### As Exemplary Draw Furnace

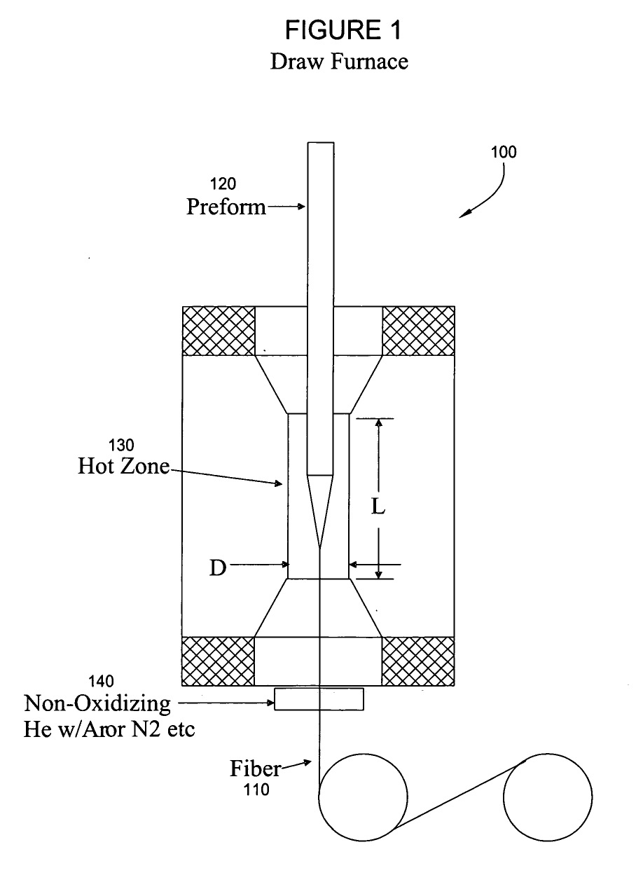

FIG. 1 illustrates an exemplary draw furnace in accordance with embodiments of the present invention that may be used to draw a radiation hardened fiber 110 from a preform 120. As illustrated, the preform 120 is fed into the furnace and enters a hot zone 130, where the preform softens and begins to melt. Below (e.g., at the bottom of a draw tower), the fiber 110 may be pulled and wound onto spools.

For some embodiments, the preform 120 may be doped with materials chosen to enhance radiation resistance. For example, for some embodiments, the preform 120 may have a pure silica (SiO₂) core with a fluorine doped silica cladding, and may be drawn into a single or multi-mode fiber. The preform 120 may be drawn at high temperature and low draw speed resulting in low draw tension. Resultant fiber 110 drawn from this process has shown to have promising radiation resistance. This reduction in radiation sensitivity may result from a reduction in internal bond strain within the fiber optical core, at the core/clad interface and/or in the cladding.

For some embodiments, the dimension of the hotzone 130 may be chosen in an effort to heat the preform evenly. As an example, for some embodiments, the hotzone 130 may have a diameter (D) that is approximately 2 to 3 times greater than that of the glass preform. For one embodiment, the hotzone 130 may be approximately 120 mm in length (L)×45 mm in diameter (D). In addition, the fiber 110 may exit the furnace through a non-oxidizing gas atmosphere element 140 that may include helium (He) which has high a heat transfer coefficient. In some cases, Argon (Ar) or nitrogen (N2) may also be added in the non-oxidizing gas atmosphere element 140.

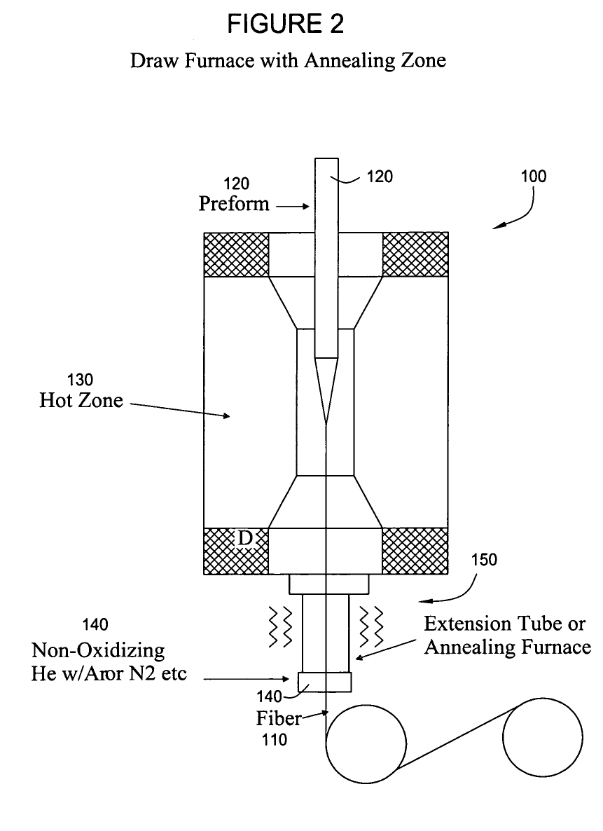

Another feature which may help reduce radiation sensitivity caused by internal stress is the addition of a secondary heating or “annealing” zone 150 below the hotzone of the fiber draw furnace. As illustrated in FIG. 2, for some embodiments, this annealing zone can be in the form of an tube extension at the bottom of the draw furnace 100 or may actually be another (secondary) furnace, or a combination of the two.

In any case, this annealing zone may allow the molten fiber to heat-soak until its temperature is even throughout. The time of the annealing may be controlled by the temperature and length of the annealing zone and may vary depending on the parameters of the fiber being drawn (e.g., fiber thickness, materials, etc.). The annealing zone may allow the fiber to slowly cool at a predetermined rate which may relax internal stresses and may increase radiation resistance. As illustrated, the fiber 110 may exit the annealing zone 150 through a non-oxidizing gas atmosphere element 140.

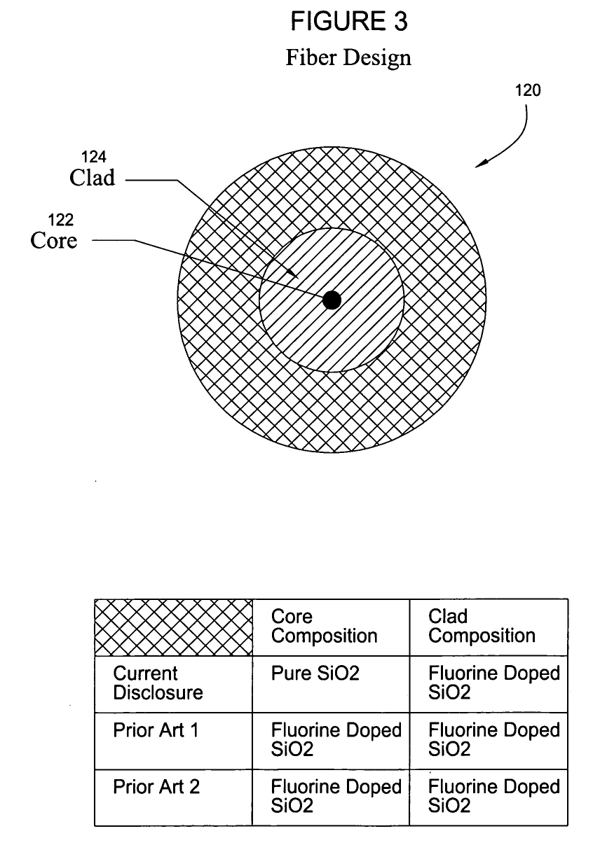

FIG. 3 shows an end view of the preform 120, along with a table of exemplary compositions of the core 122 and cladding 124. As illustrated, conventional radiation hardened fibers may be formed with preforms having fluorine doped silica cores and fluorine and/or germania doped cladding. However, utilizing the draw processes described herein, fibers of comparable radiation resistance may be achieved from preforms with pure silica cores. Eliminating the step of doping the core may facilitate the manufacturing process and reduce cost.

### CONCLUSION

While the foregoing is directed to embodiments of the present invention, other and further embodiments of the invention may be devised without departing from the basic scope thereof, and the scope thereof is determined by the claims that follow.

What is claimed is:

1. An apparatus for drawing an optical fiber from an optical fiber preform, comprising:
a first furnace for heating a first zone in which the preform is heated to draw an optical fiber therefrom; and
an annealing zone through which the drawn fiber passes after exiting the first zone to undergo an annealing process.

2. The apparatus of claim 1, further comprising a second furnace to heat the annealing zone at a different temperature than the first furnace heats the first zone.

3. A method for drawing an optical fiber from an optical fiber preform, comprising:
heating the preform in a first zone at a first temperature to draw an optical fiber therefrom; and
annealing the drawn fiber in an annealing zone after it exits the first zone, wherein the annealing zone is maintained at a second temperature.
